(19) United States
(12) Patent Application Publication
(10) Pub. No.: US 2023/0049150 A1
(43) Pub. Date: Feb. 16, 2023

(54) IMAGE FORMING APPARATUS

(71) Applicant: KYOCERA Document Solutions Inc., Osaka (JP)

(72) Inventor: Takeo MIZOBE, Osaka-shi (JP)

(73) Assignee: KYOCERA Document Solutions Inc., Osaka (JP)

(21) Appl. No.: 17/815,905

(22) Filed: Jul. 28, 2022

(30) Foreign Application Priority Data
Jul. 29, 2021 (JP) 2021-124508

(51) Int. Cl. G03G 15/16

(52) U.S. Cl. CPC G03G 15/162

(57) ABSTRACT

An image forming apparatus forms an image on a recording medium using first to fourth toners, and includes an intermediate transfer target; a primary transfer unit that transfers a first toner image, a second toner image, a third toner image, and a fourth toner image to the intermediate transfer target in stated order; and a secondary transfer unit that collectively transfers the first to fourth toner images onto the recording medium. The first toner image, the second toner image, the third toner image, and the fourth toner image include the first toner, the second toner, the third toner, and the fourth toner, respectively. The first to fourth toners each include toner particles. The toner particles each include a toner mother particle and an external additive attached to the surface of the toner mother particle. The external additive includes fluororesin particles and silica particles.

### INCORPORATION BY REFERENCE

The present application claims priority under 35 U.S.C. § 119 to Japanese Patent Application No. 2021-124508, filed Jul. 29, 2021. The contents of this application are incorporated herein by reference in their entirety.

### BACKGROUND

The present disclosure relates to an image forming apparatus.

A tandem image forming apparatus is known as an example of an image forming apparatus for color image formation. The tandem image forming apparatus adopts a direct transfer method or an intermediate transfer method, for example.

A tandem image forming apparatus adopting the direct transfer method forms toner images in different colors on respective image bearing members. The formed toner images in different colors are sequentially transferred to a recording medium conveyed by a transfer belt, thereby forming a color image on a recording medium. By contrast, a tandem image forming apparatus adopting the intermediate transfer method forms toner images in different colors on respective image bearing members. The formed toner images in different colors are primarily transferred to the intermediate transfer target sequentially in a superimposed manner. As a result, a color toner image in which the toner images in different colors are superimposed is formed on the intermediate transfer target. Subsequently, the color toner image on the intermediate transfer target is collectively secondarily transferred to the recording medium, thereby forming a color image on a recording medium.

In the tandem image forming apparatus adopting the intermediate transfer method, the toner image is pressed against the intermediate transfer target several times in primary transfer of the toner images in different colors to the intermediate transfer target. As a result, a portion of the toner image may be excessively strongly adhered to the intermediate transfer target and may not be transferred from the intermediate transfer target to the recording medium in secondary transfer. Thus, the uniformity of the image density of the formed image is lowered, and a partial region having a low image density is generated.

In a tandem image forming apparatus adopting the intermediate transfer method, an image forming apparatus using a toner containing fluororesin particles as an external additive has been proposed for improving the uniformity of image density, for example. Toners using fluororesin particles as external additive particles have low surface adhesiveness. Therefore, a toner image including the above-mentioned toners does not adhere excessively strongly even when pressed against the intermediate transfer target many times. Thus, the above-mentioned image forming apparatus is capable of inhibiting lowering of the uniformity of the image density of the formed image.

### SUMMARY

An image forming apparatus according to an aspect of the present disclosure forms an image on a recording medium using a first toner, a second toner, a third toner and a forth toner. The image forming apparatus includes: an intermediate transfer target; a primary transfer unit that transfers a first toner image including the first toner, a second toner image including the second toner, a third toner image including the third toner, and a fourth toner image including the fourth toner to the intermediate transfer target in a superimposed manner in stated order; and a secondary transfer unit that collectively transfers, to the recording medium, the first toner image, the second toner image, the third toner image, and the fourth toner image each transferred to the intermediate transfer target. The first toner, the second toner, the third toner, and the fourth toner each include toner particles. The toner particles each include a toner mother particle and an external additive attached to the surface of the toner mother particle. The external additive includes fluororesin particles and silica particles. Where F1, F2, F3, and F4 respectively represent coverage rates of the fluororesin particles of the first toner, the second toner, the third toner, and the fourth toner, F1>F2>F3>F4 is satisfied. The coverage rates each indicate an area ratio of surface regions of the toner mother particles covered with the fluororesin particles of a corresponding one of the first toner, the second toner, the third toner, and the fourth toner.

### BRIEF DESCRIPTION OF THE DRAWINGS

FIG. 1 illustrates an example of a configuration of a toner particle contained in a toner used in an image forming apparatus of the present disclosure.

FIG. 2 illustrates an example of the image forming apparatus of the present disclosure.

FIG. 3 illustrates a primary transfer unit for magenta color in FIG. 2.

### DETAILED DESCRIPTION

The following describes a preferable embodiment of the present disclosure. Note that a toner is a collection (e.g., a powder) of toner particles. An external additive is a collection (e.g., a powder) of external additive particles. Unless otherwise stated, results (e.g., values indicating shapes or properties) of evaluations performed on a powder (e.g., a powder of toner particles or a powder of external additive particles) each are a number average of values measured with respect to an appropriate number of the particles of the powder.

Unless otherwise stated, a softening point (Tm) is a value measured using a capillary rheometer (“CFT-500D”, product of Shimadzu Corporation).

Measured values for volume median diameter (D₅₀) of a powder are median diameters measured using a laser diffraction particle size analyzer (e.g., “MULTISIZER 3” produced by Beckman Coulter, Inc.) unless otherwise stated.

Unless otherwise stated, chargeability refers to chargeability at triboelectric charging. For example, a measurement target (e.g., a toner) is triboelectrically charged by mixing and stirring the measurement target with a standard carrier (standard carrier for negatively chargeable toner use: N-01, standard carrier for positively chargeable toner use: P-01) provided by The Imaging Society of Japan. When the amount of charge of the measurement target is measured using for example a compact toner draw-off charge measurement system (“MODEL 212HS”, product of TREK, INC.) before and after triboelectric charging, a larger change in the amount of charge between before and after triboelectric charging indicates stronger chargeability of the measurement target.

### <Image Forming Apparatus>

An image forming apparatus according to an embodiment of the present disclosure forms an image on a recording medium using a first toner, a second toner, a third toner, and a fourth toner. The image forming apparatus includes an intermediate transfer target, a primary transfer unit, and a secondary transfer unit. The primary transfer unit transfers a first toner image, a second toner image, a third toner image, and a fourth toner image onto the intermediate transfer target in a superimposed manner in the stated order. The secondary transfer unit collectively transfers onto the recording medium the first toner image, the second toner image, the third toner image, and the fourth toner image each transferred onto the intermediate transfer target. The first toner, the second toner, the third toner, and the fourth toner each contain toner particles. The toner particles each include a toner mother particle and an external additive attached to the surface of the toner mother particle. The external additive includes fluororesin particles and silica particles. Where F1, F2, F3, and F4 respectively represent coverage rates of the fluororesin particles of the first toner, the second toner, the third toner, and the fourth toner, F1>F2>F3>F4 is satisfied. The coverage rates (also referred to as fluororesin particle coverage rates) each indicate an area ratio of surface regions of the toner mother particles covered with the fluororesin particles of a corresponding one of the first toner, the second toner, the third toner, and the fourth toner.

The image forming apparatus of the present disclosure having the above-mentioned configuration is capable of forming an image with excellent uniformity of image density and inhibiting occurrence of toner scattering. The reason can be presumed as follows.

Each of the toners used in the image forming apparatus of the present disclosure contains fluororesin particles as an external additive. The fluororesin particles reduce the adhesiveness of the surfaces of the toner particles to ensure the uniformity of the image density of formed images. In detail, the image forming apparatus using the above-mentioned toner performs primary transfer by sequentially superimposing four toner images (a first toner image, a second toner image, a third toner image, and a fourth toner image) onto the intermediate transfer target. Since the surface of the above-mentioned toner has low adhesiveness, it is unlikely that a part of each toner image is excessively strongly adhered to the intermediate transfer target in the primary transfer. As a result, each toner image primarily transferred to the intermediate transfer target is reliably transferred from the intermediate transfer target to a recording medium in the secondary transfer. Thus, the uniformity of image density of an image formed by a known image forming apparatus using the above-mentioned toners can be ensured.

Unfortunately, a known image forming apparatus tends to cause image defects such as toner scattering when using a toner containing fluororesin particles as an external additive. The toner scattering is a phenomenon in which toner particles scatter around thin lines in for example characters in an image because of the low adhesiveness of toner particles. The toner containing fluororesin particles as an external additive is easy to cause toner scattering because of their surfaces having low adhesiveness. As described above, it has been considered difficult to improve the uniformity of the image density while inhibiting occurrence of toner scattering.

By contrast, the fluororesin particle coverage rates are changed in the image forming apparatus of the present disclosure in consideration of the order of toner to be transferred to achieve both excellent image density uniformity and inhibition of toner scattering. In detail, in the image forming apparatus of the present disclosure, the first toner image is pressed by the intermediate transfer target not only in the primary transfer thereof, but also in the primary transfer of the second toner image, the primary transfer of the third toner image, and the primary transfer of the fourth toner image. That is, the first toner image is pressed by the intermediate transfer target four times. Similarly, the second toner image is pressed by the intermediate transfer target three times, the third toner image is pressed by the intermediate transfer target twice, and the fourth toner image is pressed by the intermediate transfer target once. As described above, the earlier the toner image to be primarily transferred is, the more times the toner image is pressed by the intermediate transfer target. The later the toner image to be primarily transferred is, the less times the toner image is pressed by the intermediate transfer target. Therefore, in order to inhibit a toner image primarily transferred earlier from being excessively strongly adhered to the intermediate transfer target, it is required that the surfaces of the toner particles have low adhesiveness. In the image forming apparatus of the present disclosure, the toner included in a toner image that is primarily transferred earlier has a higher fluororesin particle coverage rate. As a result, an image formed by the image forming apparatus of the present disclosure is excellent in the uniformity of the image density. The surfaces of the toner particles included in a toner image that is primarily transferred later may have relatively high adhesiveness because the toner image is pressed less times by the intermediate transfer target. Therefore, according to the image forming apparatus of the present disclosure, a toner image in which required adhesiveness of the surfaces of the toner particles is not so low includes a toner having a relatively low fluororesin particle coverage rate. As a result, according to the image forming apparatus of the present disclosure, occurrence of toner scattering can be inhibited because the amount of the fluororesin particles is relatively small in the toners in total.

[Toner]

The following describes the configuration of the image forming apparatus of the present disclosure in detail. The following describes the first toner, the second toner, the third toner, and the fourth toner (also collectively referred to as toners) used in the image forming apparatus of the present disclosure first.

The toners can be suitably used as a positively chargeable toner for electrostatic latent image development, for example. Each of the toners can be used as a one-component developer. When used as a one-component developer, the toner is positively charged for example by rubbing against a developer bearing member or a toner charging member in a developing device. Examples of the toner charging member include a developer restricting blade. The following describes the details of the toners with reference to the drawings as appropriate.

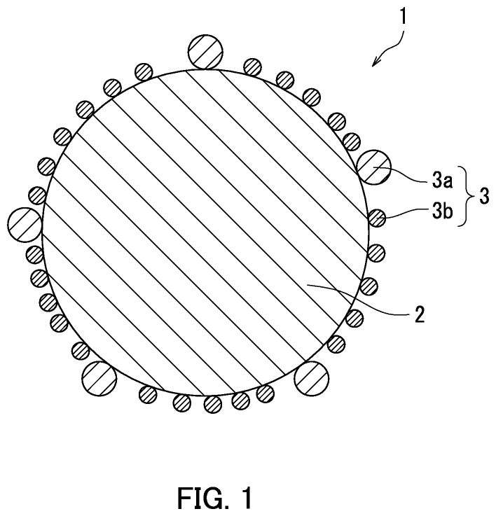

FIG. 1 illustrates an example of a toner particle 1 contained in a toner. The toner particle 1 illustrated in FIG. 1 includes a toner mother particle 2 and an external additive 3 attached to the surface of the toner mother particle 2. The external additive 3 includes fluororesin particles 3a and silica particles 3b.

The toner particles have been described above based on the drawing. However, the toner particles may have a structure different from that of the toner particles 1 in FIG. 1. Specifically, the toner particles may include particles (also referred to below as “additional external additive particles”) other than the fluororesin particles and the silica particles as the external additive. The toner mother particles may be capsule toner particles each including a toner core and a shell layer covering the toner core.

(External Additive)

The external additive is attached to the surfaces of the toner mother particles. The external additive includes fluororesin particles and silica particles.

(Fluororesin Particle)

The fluororesin particles contain a fluororesin. The percentage content of the fluororesin in the fluororesin particles is preferably at least 80% by mass, more preferably at least 95% by mass, still more preferably 100% by mass.

Examples of the fluororesin include polytetrafluoroethylene (PTFE), perfluoroalkoxyfluororesin, polychlorotrifluoroethylene, polyvinylidene fluoride, polydichlorodifluoroethylene, tetrafluoroethylen-perfluoroalkyl vinyl ether copolymers, tetrafluoroethylene-hexafluoropropylene copolymers, tetrafluoroethylene-ethylene copolymers, tetrafluoroethylene-hexafluoropropylene-perfluoroalkyl vinyl ether copolymers, and tetrafluoroethylene-perfluoroalkoxyethylene copolymers. Preferably, the fluororesin is polytetrafluoroethylene.

The fluororesin particles have a number average particle diameter of preferably at least 50 nm and no greater than 400 nm, and more preferably at least 150 nm and no greater than 250 nm. As a result of the fluororesin particles having a number average particle diameter of at least 50 nm, the fluororesin particles can be inhibited from being buried in the toner mother particles. As a result of the fluororesin particles having a number average particle diameter of no greater than 400 nm, the fluororesin particles can be inhibited from separating from the toner mother particle.

A preferable preparation method for the fluororesin particles is emulsion polymerization. The fluororesin particles obtained by the emulsification polymerization are suitably used as an external additive for toners because of being almost spherical. Alternatively, a commercially available product may be used as the fluororesin particles.

From the viewpoint of fully exerting the function of the fluororesin particles while inhibiting separation thereof from the toner mother particles, the amount of the fluororesin particles in the toner particles is preferably at least 0.1 parts by mass and no greater than 15.0 parts by mass relative to 100 parts by mass of the toner mother particles, and more preferably at least 0.5 parts by mass and no greater than 5.0 parts by mass.

(Silica Particle)

Preferably, the silica particles are subjected to surface treatment for imparting positive chargeability. The silica particles have a number average particle diameter of preferably at least 10 nm and no greater than 300 nm, more preferably at least 15 nm and no greater than 80 nm, and still more preferably at least 15 nm and no greater than 30 nm. As a result of the silica particles having a number average particle diameter of at least 10 nm, the silica particles can be inhibited from being buried in the toner mother particles. As a result of the silica particles having a number average particle diameter of no greater than 300 nm, the silica particles can be inhibited from separating from the toner mother particles.

From the viewpoint of fully exerting the function of the silica particles while inhibiting separation thereof from the toner mother particles, the amount of the silica particles in the toner particles is preferably at least 0.1 part by mass and no greater than 15.0 parts by mass relative to 100 parts by mass of the toner mother particles, and more preferably at least 0.5 parts by mass and no greater than 3.0 parts by mass.

(Additional External Additive Particles)

The external additive may further include additional external additive particles other than the fluororesin particles and the silica particles. Examples of the additional external additive particles include particles of metal oxides (specific examples include alumina, magnesium oxide, and zinc oxide), particles of organic acid compounds such as fatty acid metal salts (specific examples include zinc stearate), and resin particles. Preferably, the additional external additive particles are alumina particles. The alumina particles have number average particle diameter of preferably at least 50 nm and no greater than 400 nm, and more preferably at least 100 nm and no greater than 300 nm. As a result of the alumina particles having number average particle diameter of at least 50 nm, the alumina particles can be inhibited from being buried in the toner mother particles. As a result of the alumina particles having a number average particle diameter of no greater than 400 nm, the alumina particles can be inhibited from separating from the toner mother particles.

From the viewpoint of fully exerting the function of the alumina particles while inhibiting separation thereof from the toner mother particles, the amount of the alumina particles in the toner particles is preferably at least 0.1 part by mass and no greater than 15.0 parts by mass relative to 100 parts by mass of the toner mother particles, and more preferably at least 0.4 parts by mass and no greater than 2.0 parts by mass.

(Toner Mother Particles)

The toner mother particles contain a binder resin as a main component, for example. The toner mother particles may further contain an internal additive (e.g., at least one of a colorant, a releasing agent, a charge control agent, and a magnetic powder) as necessary. Examples of a toner mother particle production method include a pulverization method and an aggregation method, and the pulverization method is preferable.

(Binder Resin)

From the viewpoint of providing a toner excellent in low-temperature fixability, the toner mother particles preferably contain a thermoplastic resin as the binder resin and more preferably contain a thermoplastic resin at a percentage content of at least 85% by mass relative to the total of the binder resin. Examples of the thermoplastic resin include styrene resins, acrylic acid ester resins, olefin resins (e.g., polyethylene resin and polypropylene resin), vinyl resins (e.g., vinyl chloride resin, polyvinyl alcohol, vinyl ether resin, and N-vinyl resin), polyester resins, polyamide resins, and urethane resins. Alternatively, a copolymer of any of these resins, that is, a copolymer (e.g., styrene-acrylic acid ester resin or styrene-butadiene-based resin) in which any repeating unit has been introduced into any of the above resins can be used as the binder resin.

The percentage content of the binder resin in the toner mother particles is preferably at least 60% by mass and no greater than 95% by mass, and more preferably at least 75% by mass and no greater than 90% by mass.

From the viewpoint of increasing low-temperature fixability of the toner, the binder resin is preferably a polyester resin. The polyester resin is obtained by condensation polymerization of at least one polyhydric alcohol and at least one polybasic carboxylic acid. Examples of the polyhydric alcohol for synthesizing the polyester resin include dihydric alcohols (e.g., diol compounds and bisphenol compounds) and tri- or higher hydric alcohol. Examples of the polybasic carboxylic acid for synthesizing the polyester resin include dibasic carboxylic acids and tri- or higher-basic carboxylic acids. Note that a polybasic carboxylic acid derivative (e.g., an anhydride of polybasic carboxylic acid or a polybasic carboxylic acid halide) that can form an ester bond through condensation polymerization may be used instead of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A ethylene oxide adducts (e.g., polyoxyethylene (2,2)-2,2-bis (4-hydroxyphenyl)propane), and bisphenol A propylene oxide adducts.

Examples of the tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acids (specific examples include n-butenylsuccinic acid, isobutenylsuccinic acid, n-octenylsuccinic acid, n-dodecenylsuccinic acid, and isododecenylsuccinic acid).

Examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxylpropane, 1,2,4-cyclohexanetricarboxylic acid, tetra(methylenecarboxyl)methane, 1,2,7,8-octanetetracarboxylic acid, pyromellitic acid, and EMPOL trimer acid.

The polyester resin is preferably a condensation polymer of bisphenol A ethylene oxide adduct, terephthalic acid, and trimellitic anhydride.

(Colorant)

The toner mother particles may contain a colorant. The colorant can be a known pigment or dye that matches the color of the toner. From the viewpoint of forming high-quality images with the toners, the amount of the colorant is preferably at least 1 part by mass and no greater than 20 parts by mass relative to 100 parts by mass of the binder resin.

The toner mother particles may contain a black colorant. The black colorant may be carbon black, for example. Alternatively, a colorant can be used that has been adjusted to a black color using colorants such as a yellow colorant, a magenta colorant, and a cyan colorant.

The toner mother particles may contain a non-black colorant. Examples of the non-black colorant include a yellow colorant, a magenta colorant, and a cyan colorant.

At least one compound selected from the group consisting of a condensed azo compound, an isoindolinone compound, an anthraquinone compound, an azo metal complex, a methine compound, and an arylamide compound can be used as the yellow colorant. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

At least one compound selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound can be used as the magenta colorant. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

At least one compound selected from the group consisting of a copper phthalocyanine compound, an anthraquinone compound, and a basic dye lake compound can be used as the cyan colorant. Examples of the cyan colorant include C.I. Pigment Blue (1, 7, 15, 15:1, 15:2, 15:3, 15:4, 60, 62, or 66), Phthalocyanine Blue, C.I. Vat Blue, and C.I. Acid Blue.

(Releasing Agent)

The toner mother particles may contain a releasing agent. The releasing agent is used for the purpose of imparting offset resistance to the toner, for example. From the viewpoint of imparting sufficient offset resistance to the toner, the amount of the releasing agent is preferably at least 1 part by mass and no greater than 20 parts by mass relative to 100 parts by mass of the binder resin.

Examples of the releasing agent include aliphatic hydrocarbon-based waxes, oxides of aliphatic hydrocarbon-based waxes, plant waxes, animal waxes, mineral waxes, ester waxes of which main component is a fatty acid ester, and waxes in which a part or all of a fatty acid ester has been deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include polyethylene oxide wax and block copolymers of polyethylene oxide wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes of which main component is a fatty acid ester include montanic acid ester wax and castor wax. Examples of the waxes in which a part or all of a fatty acid ester has been deoxidized include deoxidized carnauba wax. Preferably, the releasing agent is carnauba wax.

In a case in which the toner mother particles contain a releasing agent, a compatibilizer may be added to the toner mother particles in order to improve compatibility between the binder resin and the releasing agent.

(Charge Control Agent)

The toner mother particles may contain a charge control agent. The charge control agent is used for the purpose of providing a toner with excellent charge stability or an excellent charge rise characteristic, for example. The charge rise characteristic of a toner is an indicator as to whether or not the toner can be charged to a specific charge level in a short period of time. The cationic strength of the toner mother particles can be increased through the toner mother particles containing a positively chargeable charge control agent.

Examples of the positively chargeable charge control agent include azine compounds, direct dyes, acid dyes, alkoxylated amine, alkylamide, quaternary ammonium salt compounds, and resins having a quaternary ammonium cation group. Preferably, the charge control agent is a quaternary ammonium salt compound.

From the viewpoint of obtaining a toner having excellent charge stability, the amount of the charge control agent is preferably at least 0.1 parts by mass and no greater than 30 parts by mass relative to 100 parts by mass of the binder resin, and more preferably at least 1 part by mass and no greater than 5 parts by mass.

[Toner Production Method]

The toner can be produced by a production method including a toner mother particle preparation process and an external additive addition process.

(Toner Mother Particle Preparation Process)

In the toner mother particle preparation process, the toner mother particles are prepared by an aggregation method or a pulverization method, for example.

The aggregation method includes an aggregation process and a coalescence process. The aggregation process involves causing fine particles containing components constituting the toner mother particles to aggregate in an aqueous medium to form aggregated particles. The coalescence process involves causing components contained in the aggregated particles to coalesce in the aqueous medium to form the toner mother particles.

The pulverization method will be described next. The pulverization method can relatively easily achieve preparation of the toner mother particles and can reduce production cost. In a case in which the toner mother particle are prepared by the pulverization method, the toner mother particle preparation process includes a melt-kneading process and a pulverization process, for example. The toner mother particle preparation process may further include a mixing process before the melt-kneading process. Furthermore, the toner mother particle preparation process may further include at least one of a fine pulverization process and a classification process after the pulverization process.

In the mixing process, the binder resin and the internal additive added as necessary are mixed to yield a mixture. In the melt-kneading process, a toner material is melted and kneaded to yield a melt-kneaded product. The mixture obtained in the mixing process is used as the toner material, for example. In the pulverization process, the resultant melt-kneaded product is cooled to for example room temperature (25° C.) and pulverized to yield a pulverized product. In a case in which it is necessary to reduce the diameter of the pulverized product obtained in the pulverization process, a process (a fine pulverization process) of further pulverizing the pulverized product may be performed. In order to average the particle diameter of the pulverized product, the resultant pulverized product may be classified (a classification process). Through the above processes, the toner mother particles that correspond to the pulverized product are obtained.

(External Additive Addition Process)

In the external additive addition process, the external additive including the fluororesin particles and the silica particles is attached to the surfaces of the toner mother particles to obtain the toner particles. No particular limitations are placed on a method for attaching the external additive to the surfaces of the toner mother particles, and an example of the method is a method in which the toner mother particles and the external additive are stirred using for example a mixer.

[Details of Image Forming Apparatus]

The following describes the details of the image forming apparatus of the present disclosure with reference to the drawings. In the drawings, the same reference signs represent the same or corresponding parts. For the sake of clarity and simplification of the drawings, dimensional relationships such as length, width, thickness, and depth are changed as appropriate and do not represent actual dimensional relationships.

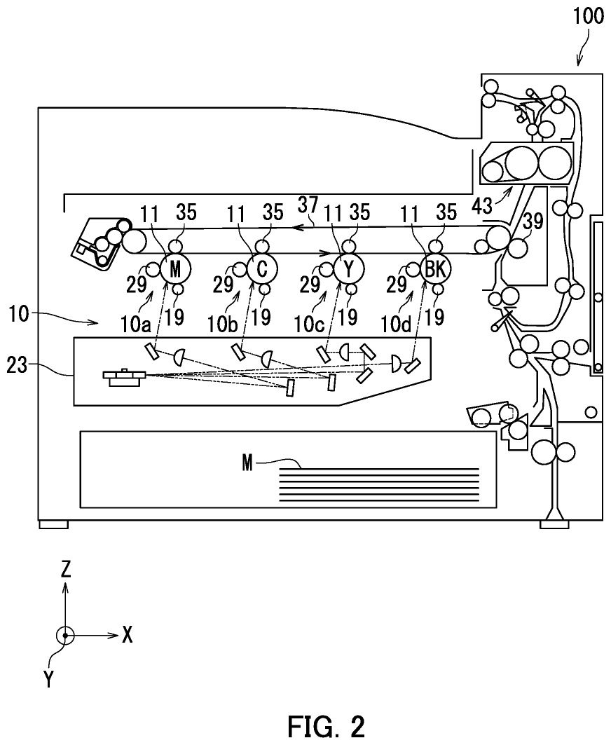

FIG. 2 illustrates an image forming apparatus 100 which is an example of the image forming apparatus of the present disclosure. The image forming apparatus 100 illustrated in FIG. 2 forms an image on a recording medium M (e.g., printing paper) using a first toner, a second toner, a third toner, and a fourth toner, which are one-component developing agents. The image forming apparatus 100 includes an intermediate transfer belt 37, a primary transfer unit 10, an exposure section 23, a secondary transfer unit 39, and a fixing section 43.

The intermediate transfer belt 37 rotates in a specific direction (anticlockwise in FIG. 2). The primary transfer unit 10 includes a primary transfer unit 10a for magenta color, a primary transfer unit 10b for cyan color, a primary transfer unit 10c for yellow color, and a primary transfer unit 10a for black color disposed in the stated order from the upstream in terms of the rotation direction of the intermediate transfer belt 37. The primary transfer unit 10 transfers, to the intermediate transfer belt 37, a first toner image (magenta toner image) including the first toner, a second toner image (cyan toner image) including the second toner, and a third toner image (yellow toner image) including the third toner, and a fourth toner image (black toner image) including the fourth toner in the stated order in a superimposed manner.

In detail, first, the primary transfer unit 10a for magenta color forms the first toner image, and transfers it to a specific region (also referred to as an image forming region) on the intermediate transfer belt 37. Subsequently, the intermediate transfer belt 37 rotates to move the image forming region to the position where the primary transfer unit 10b for cyan color is located. Subsequently, the primary transfer unit 10b for cyan color forms the second toner image and transfers it to the intermediate transfer belt 37 on which the first toner image has been transferred in a superimposed manner. Subsequently, the intermediate transfer belt 37 rotates to move the image forming region to the position where the primary transfer unit 10c for yellow color is located. Subsequently, the primary transfer unit 10c for yellow color forms the third toner image and transfers it to the intermediate transfer belt 37 on which the first toner image and the second toner image have been transferred in a superimposed manner. Subsequently, the intermediate transfer belt 37 rotates to move the image forming region to the position of the primary transfer unit 10d for black color. Subsequently, the primary transfer unit 10d for black color forms the forth toner image and transfers it to the intermediate transfer belt 37 on which the first toner image, the second toner image and the third toner image have been transferred in a superimposed manner. As a result, a toner image in which the first toner image, the second toner image, the third toner image, and the fourth toner image are superimposed (also referred to as a color toner image) is formed in the image forming region of the intermediate transfer belt 37.

Subsequently, the intermediate transfer belt 37 rotates to move the image forming region to the position where the secondary transfer unit 39 is located. The recording medium M is also transferred to the position where the secondary transfer unit 39 is located. Next, the secondary transfer unit 39 collectively transfers (secondary transfer), to the recording medium M, the color toner image transferred to the intermediate transfer belt 37. The fixing section 43 fixes, to the recording medium M, the color toner image transferred to the recording medium M. As a result, a desired color image is formed on the recording medium M. It should be noted that no toner image is transferred to an area of the intermediate transfer belt 37 from the downstream of the secondary transfer unit 39 to the upstream of the primary transfer unit 10a for magenta color.

The first toner image, the second toner image, the third toner image, and the forth toner include the first toner, the second toner, the third toner and the forth toner, respectively. Each toner has the above-mentioned features. In FIG. 2, the first toner is magenta toner. Therefore, it is preferable that the toner mother particles of the first toner contain a magenta colorant. The second toner is cyan toner. Therefore, it is preferable that the toner mother particles of the second toner contain a cyan colorant. The third toner is yellow toner. Therefore, it is preferable that the toner mother particles of the third toner contain a yellow colorant. The fourth toner is black toner. Therefore, it is preferable that the toner mother particles of the fourth toner contain a black colorant.

As described above, each toner contains fluororesin particles as an external additive. Where F1, F2, F3 and F4 represent fluororesin particle coverage rates of the first toner, the second toner, the third toner and the fourth toner, respectively, F1>F2>F3>F4 is satisfied.

The coverage rates of F1, F2, F3 and F4 each are preferably at least 0.30 area percent and no greater than 5.00 area percent, and more preferably at least 0.90 area percent and no greater than 3.50 area percent. As a result of that the coverage rates F1, F2, F3 and F4 each being at least 0.30 area percent, the image forming apparatus of the present disclosure can form an image having further excellent uniformity of the image density. As a result of that the coverage rates F1, F2, F3 and F4 each being no greater than 0.30 area percent, occurrence of toner scattering can be inhibited more effectively according to the image forming apparatus of the present disclosure.

The differences between F1 and F2, between F2 and F3, and between F3 and F4 are preferably at least 0.30 area percent and no greater than 1.50 area percent. As a result of the above differences being at least 0.30 area percent and no greater than 1.50 area percent, the image forming apparatus of the present disclosure can form an image having further excellent uniformity of image density, and suppressing the occurrence of toner scattering more effectively.

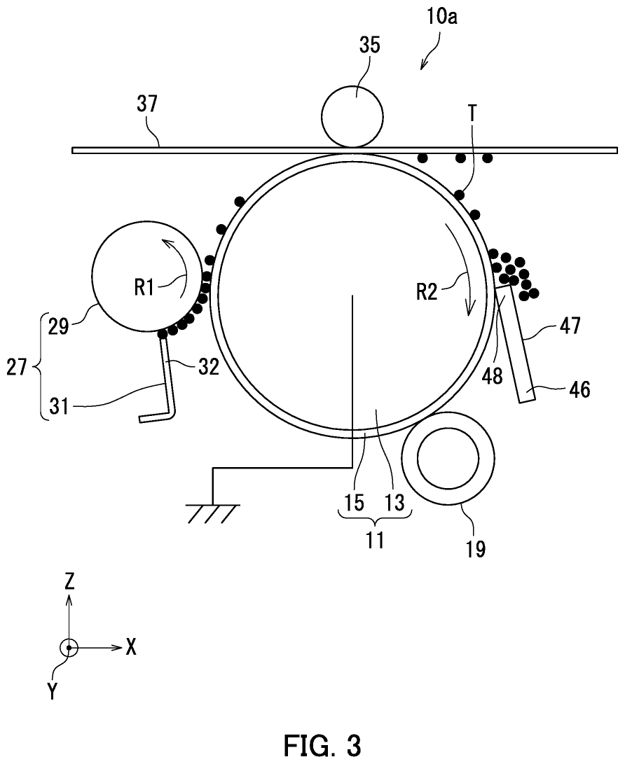

FIG. 3 illustrates the primary transfer unit 10a for magenta color. The primary transfer unit 10a for magenta color includes an image bearing member 11, a charger 19, a developing section 27, a primary transfer roller 35, and a cleaning member 47. The primary transfer unit 10a for magenta color uses a first toner T. The primary transfer unit 10b for cyan color, the primary transfer unit 10c for yellow color, and the primary transfer unit 10d for black color have substantially the same configuration as the primary transfer unit 10a for magenta color, except that the types of toner used are different.

The image bearing member 11 illustrated in FIG. 3 bears an electrostatic latent image on the surface (peripheral surface) thereof. The first toner T is electrically attracted to the electrostatic latent image. As a result, the first toner image can be formed on the surface of the image bearing member 11. The charger 19 is provided around the image bearing member 11 and uniformly charges the surface of image bearing member 11. The light exposure section 23 (not illustrated in FIG. 3) exposes the uniformly charged surface of the image bearing member 11 to light to form an electrostatic latent image on the surface of the image bearing member 11. The developing section 27 accommodates the first toner T, which is a one-component developer. The developing section 27 develops the electrostatic latent image using the first toner T. The primary transfer roller 35 is opposite to the image bearing member 11 with the intermediate transfer belt 37 therebetween, and transfers the first toner image to the intermediate transfer belt 37. The cleaning member 47 is pressed against the surface of the image bearing member 11 and removes first toner T (specifically, post-transfer residual toner) remaining on the surface of the image bearing member 11 from the surface of the image bearing member 11.

When a portion of the image bearing member 11 opposite to the primary transfer roller 35 is assumed to be a base point in a rotation direction R2 of the image bearing member 11, the cleaning member 47 is located downstream of the primary transfer roller 35 in the rotation direction R2 of the image bearing member 11. The charger 19 is located downstream of the cleaning member 47 in the rotation direction R2 of the image bearing member 11. By contrast, the developer bearing member 29 included in the developing section 27 is located upstream of the primary transfer roller 35 in the rotation direction R2 of the image bearing member 11.

The following describes an image formation method using the image forming apparatus 100. The image formation method using the image forming apparatus 100 includes a charging process, an exposure process, a developing process, a primary transfer process, a secondary transfer process, a fixing process, and a cleaning process. In detail, in the charging process, the charger 19 uniformly charges the surface of the image bearing member 11. In the exposure process, the light exposure section 23 exposes the surface of the uniformly charged image bearing member 11 to light. As a result, an electrostatic latent image is formed on the surface of the image bearing member 11. The formed electrostatic latent image is borne on the surface of the image bearing member 11.

In the developing process, the developing section 27 of the magenta primary transfer unit 10a for magenta color develops the electrostatic latent image using the first toner T. As a result, the first toner image is formed on the surface of the image bearing member 11. Specifically, the first toner T is electrically attracted to the surface of the developer bearing member 29 from an accommodating member (not illustrated). Through the above, the first toner T is borne on the surface of the developer bearing member 29, and a toner layer including the first toner T is formed on the surface of developer bearing member 29. Subsequently, when the developer bearing member 29 rotates in a rotation direction R1, the first toner T included in the toner layer is supplied from the surface of the developer bearing member 29 to the surface of the image bearing member 11. As a result, the first toner T is supplied onto the electrostatic latent image, and the first toner image is formed on the surface of the image bearing member 11.

In the primary transfer process, the primary transfer roller 35 transfers the first toner image from the image bearing member 11 to the intermediate transfer belt 37. The primary transfer unit 10a for magenta color, the primary transfer unit 10b for cyan color, the primary transfer unit 10c for yellow color, and the primary transfer unit 10d for black color each perform the charging process to the primary transfer process described above. As a result, a color toner image is formed on the intermediate transfer belt 37 after the primary transfer process.

In the secondary transfer process, the secondary transfer unit 39 collectively transfers the color toner image from the intermediate transfer belt 37 to the recording medium M.

In the fixing process, the fixing section 43 fixes, to the recording medium M, the unfixed color toner image transferred to the recording medium M by applying either or both heat and pressure. As a result, an image is fixed on the recording medium M.

The cleaning process is performed in each of the primary transfer unit 10a for magenta color, the primary transfer unit 10b for cyan color, the primary transfer unit 10c for yellow color, and the primary transfer unit 10d for black color. In the cleaning process, the cleaning member 47 removes the post-transfer residual toner from the surface of the image bearing member 11. The following describes the image bearing member 11, the developing section 27, and the cleaning member 47 in detail.

The image bearing member 11 is rotatably supported by the housing of the image forming apparatus 100. More specifically, the image bearing member 11 is driven by, for example, a motor (not illustrated) and rotates in the rotation direction R2. The image bearing member 11 corresponds to a photosensitive drum. The image bearing member 11 includes a conductive substrate 13, and a photosensitive layer 15.

The conductive substrate 13 is preferably a cylindrical tube made from metal. Examples of the metal constituting the tube include aluminum, iron, titanium, and magnesium.

The photosensitive layer 15 may be an organic photosensitive layer using an organic photoconductor or an inorganic photosensitive layer using an inorganic photoelectric conductor. For example, the photosensitive layer 15 is preferably an amorphous silicon photosensitive layer (also referred to as “a-Si photosensitive layer”) formed by vapor deposition of silane gas. Enhancement of the durability of the photosensitive layer 15 can be achieved where the photosensitive layer 15 is an a-Si photosensitive layer. This makes it possible to inhibit the surface shape of the image bearing member 11 from changing even when the image forming apparatus 100 is used for a long period of time.

The developing section 27 includes a developer bearing member 29, and a developer restricting member 31. The developer bearing member 29 is disposed around the image carrier 11 in contact with the image bearing member 11 and bears, on the surface, the first toner T which is a one-component developer. In the developing process, the developer bearing member 29 bearing the first toner T causes the first toner T to be borne by the image bearing member 11. The developer bearing member 29 corresponds to a development roller.

Preferably, the developer bearing member 29 is connected to an accommodating member (not illustrated). For example, the developer bearing member 29 that bears the first toner T is connected to an accommodating member that accommodates the first toner T. As a result, in the developing process, the first toner T is supplied from the accommodating member to the developer bearing member 29. The accommodating member corresponds to a cartridge.

The developer restricting member 31 is disposed in the axial direction of the developer bearing member 29 so as to be opposite to the surface of the developer bearing member 29. A tip portion 32 of the developer restricting member 31 is in contact with the surface of the developer bearing member 29. This can make the developer restricting member 31 to restrict the thickness of the toner layer. The “tip portion 32 of the developer restricting member 31” indicates a portion of the developer restricting member 31 opposite to the surface of the developer bearing member 29. The developer restricting member 31 corresponds to a developer restricting blade. Preferably, the material of the developer restricting blade is rubber.

The cleaning member 47 is disposed in the axial direction of the image bearing member 11 and is pressed against the surface of the image bearing member 11. More specifically, it is preferable that a tip portion 48 of the cleaning member 47 is pressed against the surface of the image bearing member 11. At the contact point between the tip portion 48 of the cleaning member 47 and the surface of the image bearing member 11, the rotation direction R2 of the image bearing member 11 is opposite to the direction from a base portion 46 to the tip portion 48 of the cleaning member 47. This can make the cleaning member 47 to remove the post-transfer residual toner. The cleaning member 47 corresponds to a cleaning blade. Preferably, the material of the cleaning blade is rubber.

The image forming apparatus 100 and the image formation method using the image forming apparatus 100 have been described above with reference to FIGS. 2 and 3. However, the image forming apparatus of the present disclosure is not limited to the image forming apparatus 100 described with reference to FIGS. 2 and 3, and can be appropriately changed within the scope of the purpose of the present disclosure.

For example, in the image forming apparatus 100 described with reference to FIGS. 2 and 3, the first toner T, the second toner, the third toner, and the fourth toner are a magenta toner, a cyan toner, a yellow toner, and a black toner, respectively. However, in the image forming apparatus of the present disclosure, the relationship between each toner and its color may be different from the above-mentioned relationship. In addition, the image forming apparatus 100 described with reference to FIGS. 2 and 3 includes an intermediate transfer belt 37 as an intermediate transfer target. However, in the image forming apparatus of the present disclosure, the intermediate transfer target may be a member (e.g., a drum-shaped intermediate transfer target) having any shape except the belt shape. Moreover, the image forming apparatus of the present disclosure includes the intermediate transfer target, the primary transfer unit, and the secondary transfer unit as essential elements, and may include any other elements. In addition, the primary transfer unit may have any configuration as long as it has a function of transferring a toner image onto the intermediate transfer target. The image formation method using the image forming apparatus of the present disclosure need only include at least a charging process, an exposure process, a developing process, a primary transfer process, and a secondary transfer process.

### EXAMPLES

Examples of the present disclosure will be described as follows, but the present disclosure is not limited to the scope of the examples. Measurement method of each physical property value will be explained first.

[Number Average Particle Diameter]

The number average particle diameter of external additive particles was determined from a particle projection image taken using a scanning electron microscope (“JSM-7600F”, product of JEOL Ltd.). In detail, the external additive particles were observed at a magnification of 50,000×, and the average of the equivalent circle diameters of 1000 external additive particles were taken as the number average primary particle diameter of the external additive particles.

[Fluororesin Particle Coverage Rate]

Fluororesin particle coverage rates were measured as follows. First, toner particles of toners that were measure targets were observed using a scanning electron microscope (SEM, “JSM-7600F” manufactured by JEOL Ltd.) at a magnification of 10,000× to obtain an SEM photographed image. Energy dispersive X-ray spectroscopic analysis (EDX) was carried out to map the constituent element (fluorine atom) unique to the fluororesin particles in the SEM image. By the image analysis of the SEM image, a total area Ft of the surfaces of the toner mother particles and an area of the region of the surfaces of the toner mother particles to which the fluororesin particles are attached (the area of the mapped region) Fi were calculated. The fluororesin particle coverage [area percent] was calculated from the calculated Fi and Ft using formula (1).

Fluororesin particle coverage rate=100×Fi/Ft (1)

(Preparation of Fluororesin Particles A)

An autoclave equipped with a stainless steel anchor type stirring blade and a temperature control jacket was used as a reaction vessel. The reaction vessel was charged with 3580 mL of deionized water, 3.58 g of ammonium perfluorooctanoate, and 94.1 g of paraffin wax (“PARAFFIN WAX-130”, product of Nippon Seiro Co., Ltd.). After replacement of the inside of the reaction vessel with nitrogen gas and tetrafluoroethylene (TFE), TFE was further injected into the reaction vessel. The contents of the reaction vessel were stirred at a stirring speed of 250 rpm (also referred to as stirring speed X) while heating contents of the reaction vessel to 80° C., and kept at this temperature. TFE was kept supplying so that the pressure in the reaction vessel became constant (0.78 MPa) while an aqueous solution of ammonium persulfate (concentration: 0.067% by mass) and an aqueous solution of disuccinic acid peroxide (concentration: 1.61% by mass) were being injected. The above caused a polymerization reaction for 50 minutes (also referred to as polymerization time Y). In the polymerization reaction, the injection amount of the aqueous solution of ammonium persulfate was 20 mL, the injection amount of the aqueous solution of disuccinic acid peroxide was 20 mL, and the injection amount of TFE was 1735 g. After 50 minutes from the start of the polymerization, the supply of the TFE and the stirring of the contents of the reaction vessel were stopped to terminate the polymerization reaction. To the latex-like reaction product obtained by the polymerization reaction, 100 mL of an aqueous solution of ammonium hydroperfluorononanoate (concentration: 10% by mass) was added. Then, warm water was added to the reaction product to adjust the temperature of the reaction product to 50° C. Next, 10 mL of nitric acid (concentration: 60% by mass) was added to the reaction product while the reaction product was stirred at a stirring speed of 250 rpm. As a result, fluororesin particles A began to coagulate from the reaction product. Next, the reaction product was kept being stirred for 1 hour to sufficiently separate the solvent form the fluororesin particles A. Then, the solvent was removed from the fluororesin particles A. The fluororesin particles A were dried, thereby obtaining fluororesin particles A having a number average particle diameter of 200 nm.

(Preparation of Fluororesin Particles B)

The fluororesin particles B were prepared by the same method as that for preparing the fluororesin particles A in all aspects except that the stirring speed X was changed to 200 rpm and the polymerization time Y was changed to 60 minutes. The fluororesin particle B had a number average particle diameter of 300 nm.

(Preparation of Fluororesin Particles C)

The fluororesin particles C were prepared by the same method as that for preparing the fluororesin particles A in all aspects except that the polymerization time Y was changed to 40 minutes. The fluororesin particle C had a number average particle diameter of 100 nm.

[Toner Preparation]

Toners used in examples and comparative examples were prepared by the following methods. Details of the toners are shown in Table 1 below.

(Preparation of Polyester Resin)

A reaction vessel was charged with 1.0 mol of polyoxyethylene(2.2)-2,2-bis(4-hydroxyphenyl)propane, 4.5 mol of terephthalic acid, 0.5 mol of trimellitic anhydride, and 4 g of dibutyl tin oxide. The contents of the reaction vessel were reacted at 230° C. for 8 hours in a nitrogen atmosphere. Then, the contents of the reaction vessel were distilled under reduced pressure at a pressure of 8.3 kPa to remove an unreacted material. The resultant reaction product was washed and dried. Through the above, a polyester resin having a softening point of 120° C. was obtained. The obtained polyester resin was used as a binder resin.

(Preparation of Yellow Toner Mother Particles)

An FM mixer (“FM20B”, product of Nippon Coke Industries Co., Ltd.) was used to mix 100 parts by mass of the above-mentioned polyester resin, 4 parts by mass of a yellow pigment (“C.I. Pigment Yellow 180”, product of Sanyo Pigment Co., Ltd.) as a colorant, 5 parts by mass of carnauba wax (“CARNAUBA 1”, product of Hiroyuki Kato Co., Ltd.) as a wax, and 3 parts by mass of a quaternary ammonium salt compound (“FCA201PS”, product of Fujikura Kasei Co., Ltd.) as a charge control agent.

The obtained mixture was melt-kneaded at 150° C. using a twin-screw extruder (“TEM45”, product of Toshiba Machine Co., Ltd.). The resultant kneaded product was cooled. The cooled kneaded product was coarsely pulverized using an impact type screen fine pulverizer (“FEATHER MILL” (registered Japanese trademark) FM-2S 350×600 type”, product of Hosokawa Micron Corporation). The obtained coarsely pulverized product was finely pulverized using a supersonic jet pulverizer (“JET MILL IDS-2”, product of Nippon Pneumatic Mfg. Co., Ltd.). The obtained finely pulverized product was classified using a classifier (“ELBOW JET EJ-LABO”, product of Nittetsu Mining Co., Ltd.). Through the above, yellow toner mother particles were obtained. The yellow toner mother particles had a volume median diameter (D₅₀) of 7 μm.

(Preparation of Cyan Toner Mother Particles)

Cyan toner mother particles were prepared by the same method as the preparation of the yellow toner mother particles except that 3 parts by mass of a cyan pigment (“C.I. PIGMENT BLUE 15: 1”, product of SANYO COLOR WORKS, Ltd.) was used as a colorant.

(Preparation of Magenta Toner Mother Particles)

Magenta toner mother particles were prepared by the same method as the preparation of the yellow toner mother particles except that 3 parts by mass of a magenta pigment (“C.I. PIGMENT RED 122”, product of SANYO COLOR WORKS, Ltd.) was used as a colorant.

(Preparation of Black Toner Mother Particles)

Black toner mother particles were prepared by the same method as the preparation of the yellow toner mother particles except that 4 parts by mass of a black pigment (“REGAL (registered Japanese trademark) 330R”, product of Cabot Corporation, carbon black) was used as a colorant.

(External Additive Addition)

A container was charged with 100 parts by mass of the toner mother particles of any of the types shown in Table 1 below, fluororesin particles of the type and amount shown in Table 1 below, and 2.0 parts by mass of hydrophobic silica particles (“CAB-O-SIL (registered Japanese trademark) TG-7120”, product of Cabot Corporation, surface treatment agent: hexamethyldisilazane (HMDS) and cyclic silazan, number average particle diameter: about 18 nm), and 1.0 part by mass of alumina particles (“TM-5D”, product of TAIMEI CHEMICALS CO., LTD., number average particle diameter: 200 nm). The contents of the container were mixed for 5 minutes at a rotation speed of 3500 rpm using an FM mixer (“FM-10B”, product of Nippon Coke & Engineering Co., Ltd.). Accordingly, an external additive was attached to the surfaces of the toner mother particles. As a result, the toners shown in Table 1 below were obtained. Table 1 below also shows the fluororesin particle coverage rate of each toner.

TABLE 1

| | Toner | Fluororesin particles | | |
|---|---|---|---|---|
| | mother | | Addition amount | Coverage rate |
| Toner | particles | Type | [parts by mass] | [area %] |
| 1 | Y | A | 0.60 | 3.01 |
| 2 | C | A | 0.40 | 2.00 |
| 3 | M | A | 0.30 | 1.50 |
| 4 | B | A | 0.20 | 1.00 |
| 5 | Y | B | 0.65 | 2.93 |
| 6 | C | A | 0.50 | 2.51 |
| 7 | M | A | 0.45 | 2.26 |
| 8 | B | C | 0.20 | 2.00 |
| 9 | Y | C | 0.30 | 3.01 |
| 10 | C | C | 0.25 | 2.51 |
| 11 | M | A | 0.40 | 2.00 |
| 12 | B | B | 0.30 | 1.35 |
| 13 | Y | A | 0.30 | 1.50 |
| 14 | C | A | 0.30 | 1.50 |
| 15 | M | A | 0.30 | 1.50 |
| 16 | B | A | 0.30 | 1.50 |
| 17 | Y | — | 0.00 | 0.00 |
| 18 | C | — | 0.00 | 0.00 |
| 19 | M | — | 0.00 | 0.00 |
| 20 | B | — | 0.00 | 0.00 |
| 21 | Y | A | 0.20 | 1.00 |
| 22 | C | A | 0.30 | 1.50 |
| 23 | M | A | 0.40 | 2.00 |
| 24 | B | A | 0.60 | 3.01 |
| 25 | Y | C | 0.30 | 3.01 |
| 26 | C | A | 0.40 | 2.00 |
| 27 | M | B | 0.35 | 1.58 |
| 28 | B | A | 0.35 | 3.51 |

<Image Forming Apparatus>

Tandem color printers (prototype produced by KYOCERA Document Solutions Inc.) were prepared that each used a non-magnetic one-component developer and that each included an intermediate transfer belt. The above-mentioned color printers were each configured to transfer a yellow toner image, a cyan toner image, a magenta toner image, and a black toner image to the intermediate transfer belt in the stated order. Any of the toners (one-component developers) shown in Table 2 below were charged into developing devices (specifically, a yellow developing device, a cyan developing device, a magenta developing device, and a black developing device) of each of the above-mentioned color printer. The tandem color printers were used as image forming apparatuses of Examples 1 to 3 and Comparative Examples 1 to 4. A recording medium was A4-size plain paper (“C2”, product of FUJIFILM Business Innovation Corp.).

<Evaluation>

The image quality (specifically, the uniformity of the image density and the occurrence or non-occurrence of toner scattering) of formed images was evaluated for the image forming apparatuses of Examples 1 to 3 and Comparative Examples 1 to 4 by the following methods. Evaluation results are shown in Table 2 below.

[Uniformity of Image Density]

Evaluation images were consecutively printed on 100 sheets of the recording medium using the respective image forming apparatuses of Examples 1 to 3 and Comparative Examples 1 to 4. Each of the evaluation images included a solid image (printing rate 100%) and a halftone image (printing rate 50%). Each of the solid image and the halftone image was image in which a yellow toner image, a cyan toner image, a magenta toner image, and a black toner image were superimposed. The evaluation image printed on the 100th sheet was visually observed, and whether or not a region with a non-uniform image density was present in the evaluation image was determined. The uniformity of the image density was determined according to the following criteria.

(Criteria for Uniformity of Image Density)

A (good): There was no region with non-uniform image density.

B (slightly poor): There were a few regions with non-uniform image density.

C (Poor): There were regions with non-uniform image density.

[Toner Scattering]

An evaluation image was consecutively printed on 100 sheets of the recording medium using any of the image forming apparatuses of Examples 1 to 3 and Comparative Examples 1 to 4. The evaluation image was a pattern image (printing rate 5%) including a character. The character of the evaluation image printed on the 100th sheet with a loupe was observed to determine the occurrence or non-occurrence of toner scattering. Toner scattering was determined according to the following criteria.

(Criteria for Toner Scattering)

A (good): No toner scattering was observed.

B (slightly poor): Insignificant toner scattering was observed.

C (poor): Toner scattering was definitely observed.

TABLE 2

| | | | | Fluororesin Particles | | | Evaluation | |
|---|---|---|---|---|---|---|---|---|
| | | | Toner | | Addition | Coverage | Uniformity | |
| | | | mother | | amount | rate | of image | Toner |
| | Order | Toner | particles | Type | [parts by mass] | [area %] | density | scattering |
| Example 1 | 1 | 1 | Y | A | 0.60 | 3.01 | A | A |
| | 2 | 2 | C | A | 0.40 | 2.00 | | |
| | 3 | 3 | M | A | 0.30 | 1.50 | | |
| | 4 | 4 | B | A | 0.20 | 1.00 | | |
| Example 2 | 1 | 5 | Y | B | 0.65 | 2.93 | A | A |
| | 2 | 6 | C | A | 0.50 | 2.51 | | |
| | 3 | 7 | M | A | 0.45 | 2.26 | | |
| | 4 | 8 | B | C | 0.20 | 2.00 | | |
| Example 3 | 1 | 9 | Y | C | 0.30 | 3.01 | A | A |
| | 2 | 10 | C | C | 0.25 | 2.51 | | |
| | 3 | 11 | M | A | 0.40 | 2.00 | | |
| | 4 | 12 | B | B | 0.30 | 1.35 | | |
| Comparative | 1 | 13 | Y | A | 0.30 | 1.50 | B | A |
| Example 1 | 2 | 14 | C | A | 0.30 | 1.50 | | |
| | 3 | 15 | M | A | 0.30 | 1.50 | | |
| | 4 | 16 | B | A | 0.30 | 1.50 | | |
| Comparative | 1 | 17 | Y | — | 0.00 | 0.00 | C | A |
| Example 2 | 2 | 18 | C | — | 0.00 | 0.00 | | |
| | 3 | 19 | M | — | 0.00 | 0.00 | | |
| | 4 | 20 | B | — | 0.00 | 0.00 | | |
| Comparative | 1 | 21 | Y | A | 0.20 | 1.00 | B | C |
| Example 3 | 2 | 22 | C | A | 0.30 | 1.50 | | |
| | 3 | 23 | M | A | 0.40 | 2.00 | | |
| | 4 | 24 | B | A | 0.60 | 3.01 | | |
| Comparative | 1 | 25 | Y | C | 0.30 | 3.01 | A | B |
| Example 4 | 2 | 26 | C | A | 0.40 | 2.00 | | |
| | 3 | 27 | M | B | 0.35 | 1.58 | | |
| | 4 | 28 | B | A | 0.35 | 3.51 | | |

The image forming apparatuses of Examples 1 to 3 each were an image forming apparatus that forms an image on a recording medium using a first toner, a second toner, a third toner, and a fourth toner, and included an intermediate transfer target, a primary transfer unit configured to transfer a first toner image, a second toner image, a third toner image, and a fourth toner image onto the intermediate transfer target in a superimposed manner in stated order; and a secondary transfer unit configured to collectively transfer the first toner image, the second toner image, the third toner image, and the fourth toner image to a recording medium. The first toner, the second toner, the third toner, and the fourth toner each contained toner particles. The toner particles each included a toner mother particle and an external additive attached to the surface of the toner mother particle. The external additive included fluororesin particles and silica particles. Where F1, F2, F3, and F4 respectively represent fluororesin particle coverage rates of surface regions of the toner mother particles covered with the first toner, the second toner, the third toner, and the fourth toner, F1>F2>F3>F4 was satisfied. As illustrated in FIG. 2, when any of the image forming apparatuses of Examples 1 to 3 was used, images with excellent uniformity of image density were formed and occurrence of toner scattering was inhibited.

By contrast, the image forming apparatuses of Comparative Examples 1, 3 and 4 did not satisfy F1>F2>F3>F4. As a result, the image forming apparatuses of Comparative Examples 1, 3 and 4 did not achieve at least one of the uniformity of the image density and inhibition of toner scattering.

In the image forming apparatus of Comparative Example 2, the toner contained no fluororesin particles. As a result, the image forming apparatus of Comparative Example 2 achieved insufficient uniformity of image density.

What is claimed is:

1. An image forming apparatus that forms an image on a recording medium using a first toner, a second toner, a third toner, and a fourth toner, comprising:
an intermediate transfer target;
a primary transfer unit configured to transfer onto the intermediate transfer target a first toner image including the first toner, a second toner image including the second toner, a third toner image including the third toner, and a fourth toner image including the fourth toner in a superimposed manner in stated order; and
a secondary transfer unit configured to collectively transfer, to the recording medium, the first toner image, the second toner image, the third toner image, and the fourth toner image each transferred to the intermediate transfer target, wherein
the first toner, the second toner, the third toner, and the fourth toner each include toner particles,
the toner particles each include a toner mother particle and an external additive attached to the surface of the toner mother particle,
the external additive includes fluororesin particles and silica particles,
where F1, F2, F3, and F4 respectively represent coverage rates of the fluororesin particles of the first toner, the second toner, the third toner, and the fourth toner, F1>F2>F3>F4 is satisfied, the coverage rates each indicating an area ratio of surface regions of the toner mother particles covered with the fluororesin particles of a corresponding one of the first toner, the second toner, the third toner, and the fourth toner.

2. The image forming apparatus according to claim 1, wherein
F1, F2, F3 and F4 each are at least 0.30 area percent and no greater than 5.00 area percent.

3. The image forming apparatus according to claim 2, wherein
differences between F1 and F2, between F2 and F3, and between F3 and F4 each are at least 0.30 area percent and no greater than 1.50 area percent.

4. The image forming apparatus according to claim 1, wherein
the fluororesin particles have a number average particle diameter of at least 50 nm and no greater than 400 nm.
